(19) United States
(12) Patent Application Publication
(10) Pub. No.: US 2024/0128751 A1
(43) Pub. Date: Apr. 18, 2024

(54) EXTENDED DURATION AC BATTERY

(71) Applicant: Enphase Energy, Inc., Petaluma, CA (US)

(72) Inventor: Chris Morrow YOUNG, Round Rock, TX (US)

(21) Appl. No.: 18/376,299

(22) Filed: Oct. 3, 2023

Related U.S. Application Data
(60) Provisional application No. 63/415,335, filed on Oct. 12, 2022.

(51) Int. Cl. H02J 3/00; H02J 3/32; H02J 3/38; H02J 7/00

(52) U.S. Cl. CPC H02J 3/0073; H02J 3/32; H02J 3/38; H02J 7/0013; H02J 7/0063; H02J 2300/24

(57) ABSTRACT

The present disclosure provides an energy storage system. For example, an energy storage system comprises a controller configured to reduce output voltage of an AC battery of the energy storage system during off-grid operation and provide a power to a load based on a reduced output voltage.

### CROSS-REFERENCE TO RELATED TO APPLICATIONS

The present application claims the benefit of and priority to U.S. Provisional Application Ser. No. 63/415,335, filed on Oct. 12, 2022, the entire contents of which is incorporated herein by reference.

### BACKGROUND

### Field of the Disclosure

Embodiments of the present disclosure relate generally to energy storage systems, and, for example, to extended duration ac batteries configured for use with energy storage systems.

### Description of the Related Art

Conventional AC battery storage systems provide AC power during off-grid operation. The energy stored in an AC battery of an AC battery storage system can be determined by a capacity of the AC battery and a state-of-charge of the AC battery. The energy stored in the AC battery can be depleted as an integral of a power that is used by one or more loads. The power used by the one or more loads can be given by an output voltage of the AC battery storage system and an aggregate of a current drawn by the one or more loads. Typically, the AC voltage of the AC battery can be regulated to be the same as a grid supplied voltage, e.g., 120 Vac. When the AC battery is providing backup power (i.e., off-grid) with an output voltage of 120 Vac, a 10 kWh AC battery can provide about 5 kW of power for about two hours.

Accordingly, there is a need for improved AC batteries that are configured to deliver power to one or more loads for an extended period of time during off-grid operation.

### SUMMARY

In accordance with at some aspects of the present disclosure, an energy storage system comprises a controller configured to reduce output voltage of an AC battery of the energy storage system during off-grid operation and provide a power to a load based on a reduced output voltage.

In accordance with at some aspects of the present disclosure, an energy management system comprises a distributed energy resource comprising a renewable energy source, a load center connected to the renewable energy source, and an energy storage system, comprising a controller configured to reduce output voltage of an AC battery of the energy storage system during off-grid operation and provide a power to a load based on a reduced output voltage.

In accordance with at some aspects of the present disclosure, a method for use with an energy storage system comprises detecting when the energy storage system is in off-grid operation, reducing output voltage of an AC battery of the energy storage system, and providing a power to a load based on a reduced output voltage.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 is a block diagram of an energy management system, in accordance with one or more embodiments of the present disclosure;

FIG. 2 is a block diagram of an AC battery system, in accordance with at least some embodiments of the present disclosure;

FIG. 3 is a graph of voltage sag depth v. cycles, in accordance with one or more embodiments of the present disclosure; and

FIG. 4 is a method for use with the energy storage system of FIG. 1, in accordance with one or more embodiments of the present disclosure.

### DETAILED DESCRIPTION

Embodiments of the present disclosure relate to energy storage systems (e.g., AC energy storage system). For example, an energy storage system can comprise a controller configured to reduce output voltage of an AC battery of the energy storage system when no grid is present and provide a power to a load based on a reduced voltage. Compared to conventional energy storage systems, the methods and apparatus described herein can reduce a power required by one or more loads (e.g., of up to about 10% to about 20%) and can increase a power delivery time of the energy storage system by up to the same amount of (e.g., of up to about 10% to about 20%).

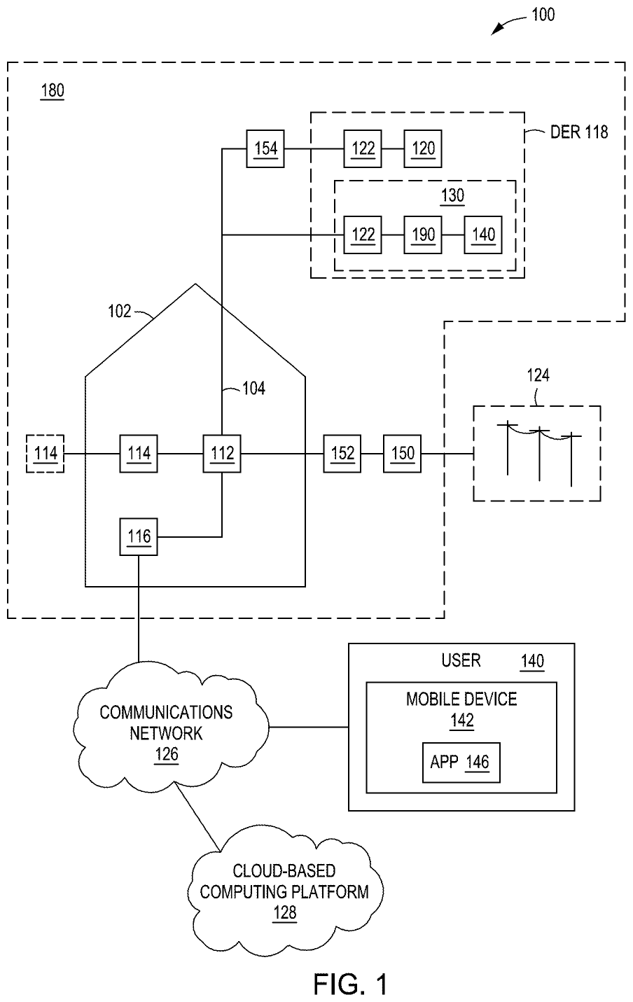

FIG. 1 is a block diagram of a system 100 (e.g., an energy management system or power conversion system) in accordance with one or more embodiments of the present disclosure. The diagram of FIG. 1 only portrays one variation of the myriad of possible system configurations. The present disclosure can function in a variety of environments and systems.

The system 100 comprises a structure 102 (e.g., a user's structure), such as a residential home or commercial building, having an associated DER 118 (distributed energy resource). The DER 118 is situated external to the structure 102. For example, the DER 118 may be located on the roof of the structure 102 or can be part of a solar farm. The structure 102 comprises one or more loads (e.g., appliances, electric hot water heaters, thermostats/detectors, boilers, water pumps, and the like), one or more energy storage devices (an energy storage system 114), which can be located within or outside the structure 102, and a DER controller 116, each coupled to a load center 112. Although the energy storage system 114, the DER controller 116, and the load center 112 are depicted as being located within the structure 102, one or more of these may be located external to the structure 102. In at least some embodiments, the energy storage system 114 can be, for example, one or more of the energy storage devices (e.g., IQ Battery 10 ®) commercially available from Enphase® Inc. of Petaluma, CA. Other energy storage devices from Enphase® Inc. or other manufacturers may also benefit from the inventive methods and apparatus disclosed herein.

The load center 112 is coupled to the DER 118 by an AC bus 104 and is further coupled, via a meter 152 and a MID 150 (e.g., microgrid interconnect device), to a grid 124 (e.g., a commercial/utility power grid). The structure 102, the energy storage system 114, DER controller 116, DER 118, load center 112, generation meter 154, meter 152, and MID 150 are part of a microgrid 180. It should be noted that one or more additional devices not shown in FIG. 1 may be part of the microgrid 180. For example, a power meter or similar device may be coupled to the load center 112. [owls] The DER 118 comprises a RES 120 (renewable energy source) coupled to a power conditioner 122 (e.g., inverter). For example, the DER 118 may comprise a plurality of RESs coupled to a plurality of power conditioners in a one-to-one correspondence (or two-to-one). In embodiments described herein, each RES 120 of the plurality of RESs is a photovoltaic module (PV module), although in other embodiments the plurality of RESs may be any type of system for generating DC power from a renewable form of energy, such as wind, hydro, and the like. The DER 118 may further comprise one or more batteries (or other types of energy storage/delivery devices) coupled to the power conditioner 122 in a one-to-one correspondence, where each pair of power conditioner 122 and a battery 141 may be referred to as an AC battery 130.

The power conditioner 122 inverts the generated DC power from the plurality of RESs 120 and/or the battery 141 to AC power that is grid-compliant and couple the generated AC power to the grid 124 via the load center 112. The generated AC power may be additionally or alternatively coupled via the load center 112 to the one or more loads and/or the energy storage system 114. In addition, the power conditioner 122 that is coupled to the battery 141 converts AC power from the AC bus 104 to DC power for charging the battery 141. A generation meter 154 is coupled at the output of the power conditioners that are coupled to the plurality of RESs in order to measure generated power.

In some alternative embodiments, the power conditioner 122 may be AC-AC converters that receive AC input and convert one type of AC power to another type of AC power. In other alternative embodiments, the power conditioner 122 may be DC-DC converters that convert one type of DC power to another type of DC power. In some of embodiments, the DC-DC converters may be coupled to a main DC-AC inverter for inverting the generated DC output to an AC output.

The power conditioner 122 may communicate with one another and with the DER controller 116 using power line communication (PLC), although additionally and/or alternatively other types of wired and/or wireless communication may be used. The DER controller 116 may provide operative control of the DER 118 and/or receive data or information from the DER 118. For example, the DER controller 116 may be a gateway that receives data (e.g., alarms, messages, operating data, performance data, and the like) from the power conditioner 122 and communicates the data and/or other information via the communications network 126 to a cloud-based computing platform 128, which can be configured to execute one or more application software, e.g., a grid connectivity control application, to a remote device or system such as a master controller (not shown), and the like. The DER controller 116 may also send control signals to the power conditioner 122, such as control signals generated by the DER controller 116 or received from a remote device or the cloud-based computing platform 128. The DER controller 116 may be communicably coupled to the communications network 126 via wired and/or wireless techniques. For example, the DER controller 116 may be wirelessly coupled to the communications network 126 via a commercially available router. In one or more embodiments, the DER controller 116 comprises an application-specific integrated circuit (ASIC) or microprocessor along with suitable software (e.g., a grid connectivity control application) for performing one or more of the functions described herein. For example, the DER controller 116 can include a memory (e.g., a non-transitory computer readable storage medium) having stored thereon instructions that when executed by a processor perform a method for grid connectivity control, as described in greater detail below.

The generation meter 154 (which may also be referred to as a production meter) may be any suitable energy meter that measures the energy generated by the DER 118 (e.g., by the power conditioner 122 coupled to the plurality of RESs 120). The generation meter 154 measures real power flow (kWh) and, in some embodiments, reactive power flow (kVAR). The generation meter 154 may communicate the measured values to the DER controller 116, for example using PLC, other types of wired communications, or wireless communication. Additionally, battery charge/discharge values are received through other networking protocols from the AC battery 130 itself.

The meter 152 may be any suitable energy meter that measures the energy consumed by the microgrid 180, such as a net-metering meter, a bi-directional meter that measures energy imported from the grid 124 and well as energy exported to the grid 124, a dual meter comprising two separate meters for measuring energy ingress and egress, and the like. In some embodiments, the meter 152 comprises the MID 150 or a portion thereof. The meter 152 measures one or more of real power flow (kWh), reactive power flow (kVAR), grid frequency, and grid voltage.

The MID 150, which may also be referred to as an island interconnect device (IID), connects/disconnects the microgrid 180 to/from the grid 124. The MID 150 comprises a disconnect component (e.g., a contactor or the like) for physically connecting/disconnecting the microgrid 180 to/from the grid 124. For example, the DER controller 116 receives information regarding the present state of the system from the power conditioner 122, and also receives the energy consumption values of the microgrid 180 from the meter 152 (for example via one or more of PLC, other types of wired communication, and wireless communication), and based on the received information (inputs), the DER controller 116 determines when to go on-grid or off-grid and instructs the MID 150 accordingly. In some alternative embodiments, the MID 150 comprises an ASIC or CPU, along with suitable software (e.g., an islanding module) for determining when to disconnect from/connect to the grid 124. For example, the MID 150 may monitor the grid 124 and detect a grid fluctuation, disturbance or outage and, as a result, disconnect the microgrid 180 from the grid 124. Once disconnected from the grid 124, the microgrid 180 can continue to generate power as an intentional island without imposing safety risks, for example on any line workers that may be working on the grid 124.

In some alternative embodiments, the MID 150 or a portion of the MID 150 is part of the DER controller 116. For example, the DER controller 116 may comprise a CPU and an islanding module for monitoring the grid 124, detecting grid failures and disturbances, determining when to disconnect from/connect to the grid 124, and driving a disconnect component accordingly, where the disconnect component may be part of the DER controller 116 or, alternatively, separate from the DER controller 116. In some embodiments, the MID 150 may communicate with the DER controller 116 (e.g., using wired techniques such as power line communications, or using wireless communication) for coordinating connection/disconnection to the grid 124.

A user 140 can use one or more computing devices, such as a mobile device 142 (e.g., a smart phone, tablet, or the like) communicably coupled by wireless means to the communications network 126. The mobile device 142 has a CPU, support circuits, and memory, and has one or more applications 146 (e.g., a grid connectivity control application) installed thereon for controlling the connectivity with the grid 124 as described herein. The one or more applications 146 may run on commercially available operating systems, such as 10S, ANDROID, and the like.

In order to control connectivity with the grid 124, the user 140 interacts with an icon displayed on the mobile device 142, for example a grid on-off toggle control or slide, which is referred to herein as a toggle button. The toggle button may be presented on one or more status screens pertaining to the microgrid 180, such as a live status screen (not shown), for various validations, checks and alerts. The first time the user 140 interacts with the toggle button, the user 140 is taken to a consent page, such as a grid connectivity consent page, under setting and will be allowed to interact with toggle button only after he/she gives consent.

Once consent is received, the scenarios below, listed in order of priority, will be handled differently. Based on the desired action as entered by the user 140, the corresponding instructions are communicated to the DER controller 116 via the communications network 126 using any suitable protocol, such as HTTP(S), MQTT(S), WebSockets, and the like. The DER controller 116, which may store the received instructions as needed, instructs the MID 150 to connect to or disconnect from the grid 124 as appropriate.

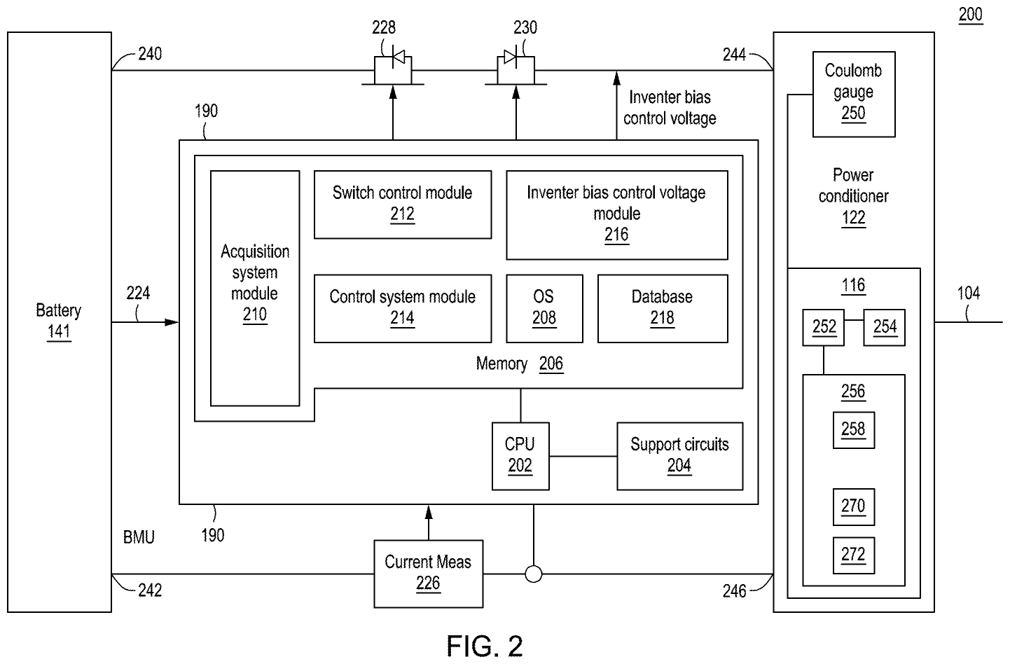

FIG. 2 is a block diagram of an AC battery system (e.g., the AC battery 130), in accordance with at least some embodiments of the present disclosure. An AC battery system configured for use with an energy management system, such as the Enphase® Energy System, is described herein. For example, FIG. 2 is a block diagram of an AC battery system 200 in accordance with one or more embodiments of the present disclosure.

The AC battery system 200 comprises a BMU 190 coupled to the battery 141 and the power conditioner 122. Additionally or alternatively, in at least some embodiments, such as when the energy storage system 114 is used, the BMU 190 can also be coupled to or a component of the energy storage system 114.

A pair of metal-oxide-semiconductor field-effect transistors (MOSFETs) switches—switches 228 and 230—are coupled in series between a first terminal 240 of the battery 141 and a first terminal of the power conditioner 122 such the body diode cathode terminal of the switch 228 is coupled to the first terminal 240 of the battery 141 and the body diode cathode terminal of the switch 230 is coupled to the first terminal 244 of the power conditioner 122. The gate terminals of the switches 228 and 230 are coupled to the BMU 190.

A second terminal 242 of the battery 141 is coupled to a second terminal 246 of the power conditioner 122 via a current measurement module 226 which measures the current flowing between the battery 141 and the power conditioner 122.

The BMU 190 is coupled to the current measurement module 226 for receiving information on the measured current, and also receives an input 224 from the battery 141 indicating the battery cell voltage and temperature. The BMU 190 is coupled to the gate terminals of each of the switches 228 and 230 for driving the switch 228 to control battery discharge and driving the switch 230 to control battery charge as described herein. The BMU 190 is also coupled across the first terminal 244 and the second terminal 246 for providing an inverter bias control voltage (which may also be referred to as a bias control voltage) to the power conditioner 122 as described further below.

The configuration of the body diodes of the switches 228 and 230 allows current to be blocked in one direction but not the other depending on state of each of the switches 228 and 230. When the switch 228 is active (i.e., on) while the switch 230 is inactive (i.e., off), battery discharge is enabled to allow current to flow from the battery 141 to the power conditioner 122 through the body diode of the switch 230. When the switch 228 is inactive while the switch 230 is active, battery charge is enabled to allow current flow from the power conditioner 122 to the battery 141 through the body diode of the switch 228. When both switches 228 and 230 are active, the system is in a normal mode where the battery 141 can be charged or discharged.

The BMU 190 comprises support circuits 204 and a memory 206 (e.g., non-transitory computer readable storage medium), each coupled to a CPU 202 (central processing unit). The CPU 202 may comprise one or more processors, microprocessors, microcontrollers and combinations thereof configured to execute non-transient software instructions to perform various tasks in accordance with embodiments of the present disclosure. The CPU 202 may additionally or alternatively include one or more application specific integrated circuits (ASICs). In some embodiments, the CPU 202 may be a microcontroller comprising internal memory for storing controller firmware that, when executed, provides the controller functionality described herein. The BMU 190 may be implemented using a general purpose computer that, when executing particular software, becomes a specific purpose computer for performing various embodiments of the present disclosure.

The support circuits 204 are well known circuits used to promote functionality of the CPU 202. Such circuits include, but are not limited to, a cache, power supplies, clock circuits, buses, input/output (I/O) circuits, and the like. The BMU 190 may be implemented using a general purpose computer that, when executing particular software, becomes a specific purpose computer for performing various embodiments of the present disclosure. In one or more embodiments, the CPU 202 may be a microcontroller comprising internal memory for storing controller firmware that, when executed, provides the controller functionality described herein.

The memory 206 may comprise random access memory, read only memory, removable disk memory, flash memory, and various combinations of these types of memory. The memory 206 is sometimes referred to as main memory and may, in part, be used as cache memory or buffer memory. The memory 206 generally stores the OS 208 (operating system), if necessary, of the DER controller 116 that can be supported by the CPU capabilities. In some embodiments, the OS 208 may be one of a number of commercially available operating systems such as, but not limited to, LINUX, Real-Time Operating System (RTOS), and the like.

The memory 206 stores non-transient processor-executable instructions and/or data that may be executed by and/or used by the CPU 202 to perform, for example, one or more methods for discharge protection, as described in greater detail below. These processor-executable instructions may comprise firmware, software, and the like, or some combination thereof. The memory 206 stores various forms of application software, such as an acquisition system module 210, a switch control module 212, a control system module 214, and an inverter bias control module 216. The memory 206 additionally stores a database 218 for storing data related to the operation of the BMU 190 and/or the present disclosure, such as one or more thresholds, equations, formulas, curves, and/or algorithms for the control techniques described herein. In various embodiments, one or more of the acquisition system module 210, the switch control module 212, the control system module 214, the inverter bias control module 216, and the database 218, or portions thereof, are implemented in software, firmware, hardware, or a combination thereof.

The acquisition system module 210 obtains the cell voltage and temperature information from the battery 141 via the input 224, obtains the current measurements provided by the current measurement module 226, and provides the cell voltage, cell temperature, and measured current information to the control system module 214 for use as described herein.

The switch control module 212 drives the switches 228 and 230 as determined by the control system module 214. The control system module 214 provides various battery management functions, including protection functions (e.g., overcurrent (OC) protection, overtemperature (OT) protection, and hardware fault protection), metrology functions (e.g., averaging measured battery cell voltage and battery current over, for example, 100 ms to reject 50 and 60 Hz ripple), state of charge (SOC) analysis (e.g., coulomb gauge 250 for determining current flow and utilizing the current flow in estimating the battery SOC; synchronizing estimated SOC values to battery voltages (such as setting SOC to an upper bound, such as 100%, at maximum battery voltage; setting SOC to a lower bound, such as 0%, at a minimum battery voltage); turning off SOC if the power conditioner 122 never drives the battery 141 to these limits; and the like), balancing (e.g., autonomously balancing the charge across all cells of a battery to be equal, which may be done at the end of charge, at the end of discharge, or in some embodiments both at the end of charge and the end of discharge). By establishing upper and lower estimated SOC bounds based on battery end of charge and end of discharge, respectively, and tracking the current flow and cell voltage (i.e., battery voltage) between these events, the BMU 190 determines the estimated SOC.

A power conditioner controller (e.g., the DER controller 116) comprises support circuits 254 and a memory 256, each coupled to a CPU 252 (central processing unit). The CPU 252 may comprise one or more processors, microprocessors, microcontrollers and combinations thereof configured to execute non-transient software instructions to perform various tasks in accordance with embodiments of the present disclosure. The CPU 252 may additionally or alternatively include one or more application specific integrated circuits (ASICs). In some embodiments, the CPU 252 may be a microcontroller comprising internal memory for storing controller firmware that, when executed, provides the controller functionality herein. The power conditioner controller may be implemented using a general purpose computer that, when executing particular software, becomes a specific purpose computer for performing various embodiments of the present disclosure.

The support circuits 254 are well known circuits used to promote functionality of the CPU 252. Such circuits include, but are not limited to, a cache, power supplies, clock circuits, buses, input/output (I/O) circuits, and the like. The power conditioner controller may be implemented using a general purpose computer that, when executing particular software, becomes a specific purpose computer for performing various embodiments of the present disclosure. In one or more embodiments, the CPU 252 may be a microcontroller comprising internal memory for storing controller firmware that, when executed, provides the controller functionality described herein.

The memory 256 may comprise random access memory, read only memory, removable disk memory, flash memory, and various combinations of these types of memory. The memory 256 is sometimes referred to as main memory and may, in part, be used as cache memory or buffer memory. The memory 256 generally stores the OS 258 (operating system), if necessary, of the DER controller 116 that can be supported by the CPU capabilities. In some embodiments, the OS 258 may be one of a number of commercially available operating systems such as, but not limited to, LINUX, Real-Time Operating System (RTOS), and the like.

The memory 256 stores non-transient processor-executable instructions and/or data that may be executed by and/or used by the CPU 252. These processor-executable instructions may comprise firmware, software, and the like, or some combination thereof. The memory 256 stores various forms of application software, such as a power conversion control module 270 for controlling the bidirectional power conversion, and a battery management control module 272.

The BMU 190 communicates with the system controller 106 to perform balancing of the battery 141 (e.g., multi-C-rate collection of AC batteries) based on a time remaining before each of the batteries are depleted of charge, to perform droop control (semi-passive) which allows the batteries to run out of charge at substantially the same time, and perform control of the batteries to charge batteries having less time remaining before depletion using batteries having more time remaining before depletion, as described in greater detail below.

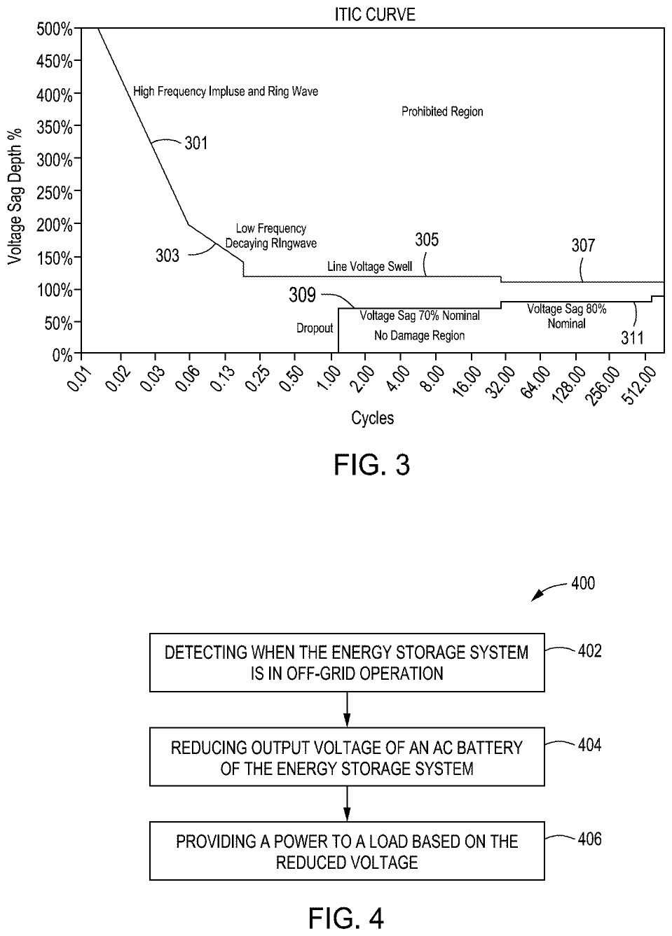

FIG. 3 is a graph of voltage sag depth v. cycles, and FIG. 4 is a method 400 for use with an energy storage system, in accordance with one or more embodiments of the present disclosure.

For example, at 402, the method 400 comprises detecting when the energy storage system (e.g., the AC battery system 200 and/or the energy storage system 114) is in off-grid operation (i.e., no grid is present/detected). For example, the power conditioner controller (e.g., the DER controller 116) of the BMU 190 can detect when the AC battery 130 is connected to the grid 124, as described above. For example, in at least some embodiments, the power conditioner controller can communicate with the MID 150 to disconnect the microgrid from the grid 124 (e.g., based on information received from the power conditioner 122 or based on a user input).

Next, at 404, the method 400 comprises reducing output voltage of an AC battery of the energy storage system during off-grid operation. For example, when the energy storage system is in off-grid operation, an output voltage of the AC battery 130 can be lowered to regulate power output from the AC battery 130 at the lowest allowable voltage. For example, as shown in FIG. 3, during normal operation, after the AC battery 130 has gone through a high-frequency impulse and ring wave phase 301 and low-frequency decaying ring wave phase 303, AC battery output can be between 70% and 120% depending on the duration of the variation from a nominal output of 120V. The lower output voltage (e.g., a reduced output voltage) can be set by a regulatory limit (e.g., automatically set by predetermined value) or as a parameter that is set by a user (e.g., manually set by a user during installation). A reduced output voltage can be about 70% for around 30 cycles (see 309) to about 80% for around 520 cycles (see 311) of the nominal AC battery output. In steady state, the output voltage can drop as low as 90% of the nominal output voltage.

Next, at 406, the method 400 comprises providing a power to a load based on the reduced output voltage. For example, when the AC battery 130 is providing backup power (e.g., during off-grid operation), an output voltage of the AC battery 130 can drop from about 70% to about 80% for brief or short periods of time, and in steady state, up to 90% of a nominal output voltage (e.g., a nominal output voltage of about 120 Vac). For example, with respect to resistive loads, e.g., power usage scales as V 2, a power to the resistive loads can be reduced by up to 20% (e.g., 90% of nominal output voltage). Thus, by reducing the power required by the resistive loads of up to 20%, an increase in a power delivery time of the AC battery can be about the same amount, e.g., about 20%. For example, a 10 kWh AC battery (e.g., the battery 141) can provide about 5 kW of power for 120 minutes, but using the methods and apparatus described herein the battery 141 can provide power for up to 144 minutes, e.g., an additional 24 minutes when the load is a resistive load.

When the battery 141 is connected to a plurality of loads, the BMU 190 can be configured to reduce voltage output by a regulatory limit or as a parameter set by a user— of the battery 141 for a specific load, e.g., connected to a load one, reduce voltage output to 95%, connected to a load two, reduce voltage output 93%, connected to a load three, reduce voltage output to 90%, etc.

In at least some embodiments, such as when a plurality of AC batteries are used, each battery 141 (or batteries) of a corresponding AC battery can be configured to provide different voltages for different loads connected to the AC battery 130. For example, when a plurality of batteries are used, each battery 141 of the plurality of AC batteries can be connected one or more loads. Each BMU 190 connected to each battery 141 can be configured to reduce each battery 141 output voltage by a regulatory limit or as a parameter set by a user. For example, when a plurality of batteries are supplying power to a plurality of corresponding loads, the BMU 190 (or a plurality of corresponding BMUs) can be configured to reduce voltage output of each battery for a specific load, e.g., battery one connected to a load one, reduce voltage output to 95%, battery two connected to a load two, reduce voltage output to 93%, battery three connected to a load three, reduce voltage output to 90%, etc.

While the foregoing is directed to embodiments of the present disclosure, other and further embodiments of the disclosure may be devised without departing from the basic scope thereof, and the scope thereof is determined by the claims that follow.

What is claimed is:

1. An energy storage system, comprising:
a controller configured to reduce output voltage of an AC battery of the energy storage system during off-grid operation and provide a power to a load based on a reduced output voltage.

2. The energy storage system of claim 1, wherein the reduced output voltage is at least one of automatically set by predetermined value or manually set by a user.

3. The energy storage system of claim 1, wherein the AC battery is configured to supply a nominal output voltage of about 120 Vac.

4. The energy storage system of claim 3, wherein the reduced output voltage of the AC battery is about 70% to about 80% of the nominal output voltage for short periods of times and 90% for steady state.

5. The energy storage system of claim 1, further comprising a plurality of AC batteries, wherein each AC battery of the plurality of AC batteries comprises a controller configured to reduce output voltage of a corresponding AC battery during off-grid operation and provide a power to a load based on the reduced output voltage.

6. The energy storage system of claim 5, wherein the reduced output voltage is the same for each AC battery.

7. The energy storage system of claim 5, wherein the reduced output voltage is different for each AC battery.

8. An energy management system, comprising:
a distributed energy resource comprising a renewable energy source;
a load center connected to the renewable energy source; and
an energy storage system, comprising:
a controller configured to reduce output voltage of an AC battery of the energy storage system during off-grid operation and provide a power to a load based on a reduced output voltage.

9. The energy management system of claim 8, wherein the lower output voltage is at least one of automatically set by predetermined value or manually set by a user.

10. The energy management system of claim 8, wherein the AC battery is configured to supply a nominal output voltage of about 120 Vac.

11. The energy management system of claim 10, wherein the reduced output voltage of the AC battery is about 70% to about 80% of the nominal output voltage for short periods of time and 90% in steady state.

12. The energy management system of claim 8, further comprising a plurality of AC batteries, wherein each AC battery of the plurality of AC batteries comprises a controller configured to reduce output voltage of a corresponding AC battery when no grid is present and provide a power to a load based on the reduced output voltage.

13. The energy management system of claim 12, wherein the reduced output voltage is the same for each AC battery.

14. The energy management system of claim 12, wherein the reduced output voltage is different for each AC battery.

15. A method for use with an energy storage system, comprising:
detecting when the energy storage system is in off-grid operation;
reducing output voltage of an AC battery of the energy storage system; and
providing a power to a load based on a reduced output voltage.

16. The method of claim 15, wherein the lower output voltage is at least one of automatically set by predetermined value or manually set by a user.

17. The method of claim 15, wherein the AC battery is configured to supply a nominal output voltage of about 120 Vac.

18. The method of claim 17, wherein the reduced output voltage of the AC battery is about 70% to about 80% of the nominal output voltage.

19. The method of claim 15, further comprising a plurality of AC batteries, wherein each AC battery of the plurality of AC batteries comprises a controller configured to reduce output voltage of a corresponding AC battery when no grid is present and provide a power to a load based on the reduced output voltage.

20. The method of claim 19, wherein the reduced output voltage is the same for each AC battery.
